(19) United States
(12) Patent Application Publication
(10) Pub. No.: US 2004/0222876 A1
(43) Pub. Date: Nov. 11, 2004

(54) Power-saving electric circuit for a remote-controlled lock

(76) Inventor: Hui-Hua Hsieh, Chung Ho City (TW)

Correspondence Address: Hui-Hua Hsieh, P.O. Box 90, Tainan City, 704, TW

(21) Appl. No.: 10/431,453

(22) Filed: May 8, 2003

(51) Int. Cl. H04Q 1/00; G05B 19/00

(52) U.S. Cl. 340/5.32; 455/343.1

(57) ABSTRACT

A power-saving electric circuit for a remote-controlled lock includes an emitter, an electric-field sensor and a receiver. The electric-field sensor receives the electric field generated by an emitter, and a power switch circuit is turned on to let the electric field connected with a main power circuit and let a power sensor sense the power after the electric field is judged by a central processing unit. The receiver receives the signal and the electric wave emitted and generated by the emitter and after decoded by a decoder, the signal and the electric wave are sent to the central processing unit for proofreading. Subsequently, a locking-unlocking circuit drives its motor to rotate clockwise or counterclockwise to unlock or lock a remote-controlled lock. The main power circuit cannot be electrically connected if the emitter emits no signal, able to economize power.

### BACKGROUND OF THE INVENTION

1. Field of the Invention

This invention relates to a power-saving electric circuit for a remote-controlled lock, particularly to one provided with an electric-field sensor and a receiver. The electric-field sensor is able to receive the electric field generated by an emitter, and a power switch circuit is turned on to let the electric field connected with a main electric circuit to let a power sensor sense the power after the electric field is judged by a central processing unit. The receiver is able to receive the signal and the electric wave emitted and generated by the emitter and after decoded by a decoder, the signal and the electric wave are sent to the central processing unit for proofreading. Subsequently, the lock locking-unlocking circuit of a drive unit drives its motor to rotate clockwise or counterclockwise to carry out unlocking or locking of a remote-controlled lock. Besides, the main electric circuit cannot be connected if the emitter does not emit any signal, nor does it generate any electric wave and electric field, able to reduce power consumption and obtain effect of power saving.

2. Description of the Prior Art

Generally, when an emitter emits signals, it will generate electric wave so that a receiver can receive the signal. Therefore, power has to maintain a connected condition all the time so as to supply the receiver with power to keep it always in a receiving condition. Under the circumstances, action current of the receiver is consumed all the time, resulting in shortening the service life of a battery. In view of the above-mentioned defect, this invention is designed to reduce the action current of the receiver. The receiver in the invention does not make electric connection until the emitter emits signals and generates electric wave, able to save power.

### SUMMARY OF THE INVENTION

This invention has been devised to offer a power-saving electric current for a remote-controlled lock, able to economize power.

The power-saving electric current for a remote-controlled lock in the present invention includes an emitter for emitting signals and generating both electric wave and electric field; an electric-field sensor for receiving the electric field generated by the emitter; a power switch circuit connected with the electric-field sensor, able to be turned on to act; a central processing unit connected with the power switch circuit to carry out judging and proofreading; a main electric current connected with the central processing unit, able to be connected; a power sensor connected with the main electric circuit and the power switch circuit, able to sense power; a receiver connected with the main electric circuit, able to receive the signal and the electric wave emitted and generated by the emitter; a decoder connected with the receiver and the central processing unit, able to decode the signal received by the receiver and then send it to the central processing unit for proofreading; a drive unit connected with the central processing unit and composed of a lock locking-unlocking circuit, an emergency action circuit, an indicator and a warning member. The lock locking-unlocking circuit is able to drive its motor to rotate clockwise or counterclockwise to carry out unlocking or locking of a remote-controlled lock. The emergency action circuit is able to actuate its electric sensor to carry out an emergency action. The indicator is able to actuate its light emitting diode to give out an indicating light, and the warning member is able to actuate its beeper to give out a warning sound.

### BRIEF DESCRIPTION OF DRAWINGS

This invention will be better understood by referring to the accompanying drawings, wherein:

FIG. 1 is a block diagram of a power-saving electric circuit for a remote-controlled lock in the present invention;

FIG. 2 is a diagram of the circuit of an emitter in the present invention;

FIG. 3 is a diagram of the circuit of an electric-field sensor and a power switch circuit in the present invention;

FIG. 4 is a diagram of the circuit of a central processing unit in the present invention;

FIG. 5 is a diagram of a main electric circuit in the present invention;

FIG. 6 is a diagram of the circuit of a power sensor in the present invention;

FIG. 7 is a diagram of the circuits of a receiver and a decoder in the present invention;

FIG. 8 is a diagram of the interior circuit of the receiver in the present invention;

FIG. 9 is a diagram of a locking-unlocking circuit in the present invention;

FIG. 10 is a diagram of an emergency action circuit in the present invention;

FIG. 11 is a diagram of the circuit of an indicator in the present invention; and,

FIG. 12 is a diagram of the circuit of a warning member in the present invention.

### DETAILED DESCRIPTION OF THE PREFERRED EMBODIMENT

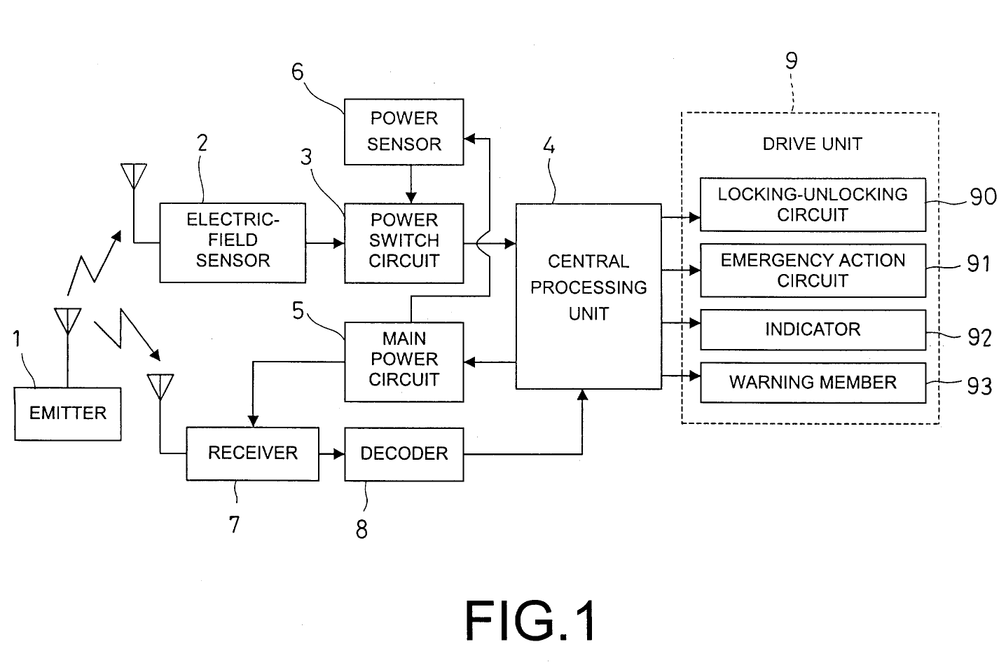

A preferred embodiment of a power-saving electric current for a remote-controlled lock in the present invention, as shown in FIG. 1, includes an emitter 1, an electric-field sensor 2, a power switch circuit 3, a central processing unit 4, a main electric circuit 5, a power sensor 6, a receiver 7, a decoder 8 and a drive unit 9.

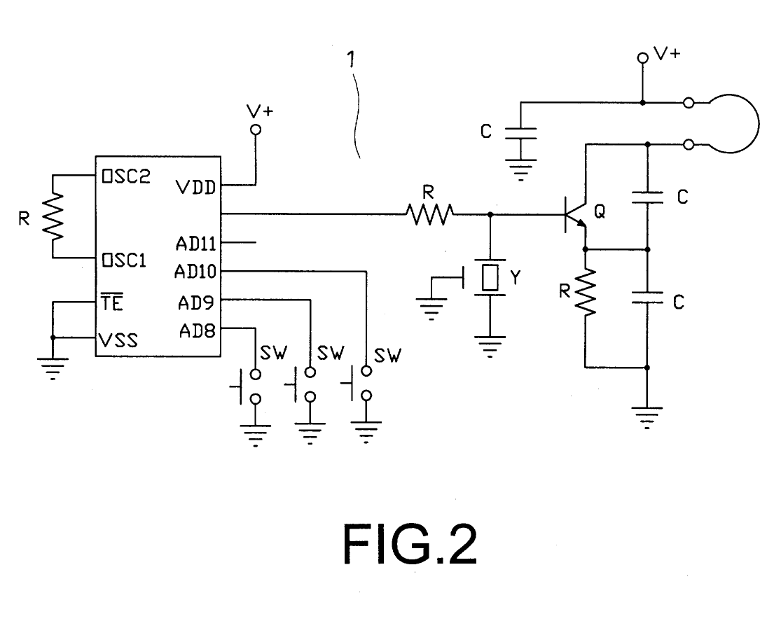

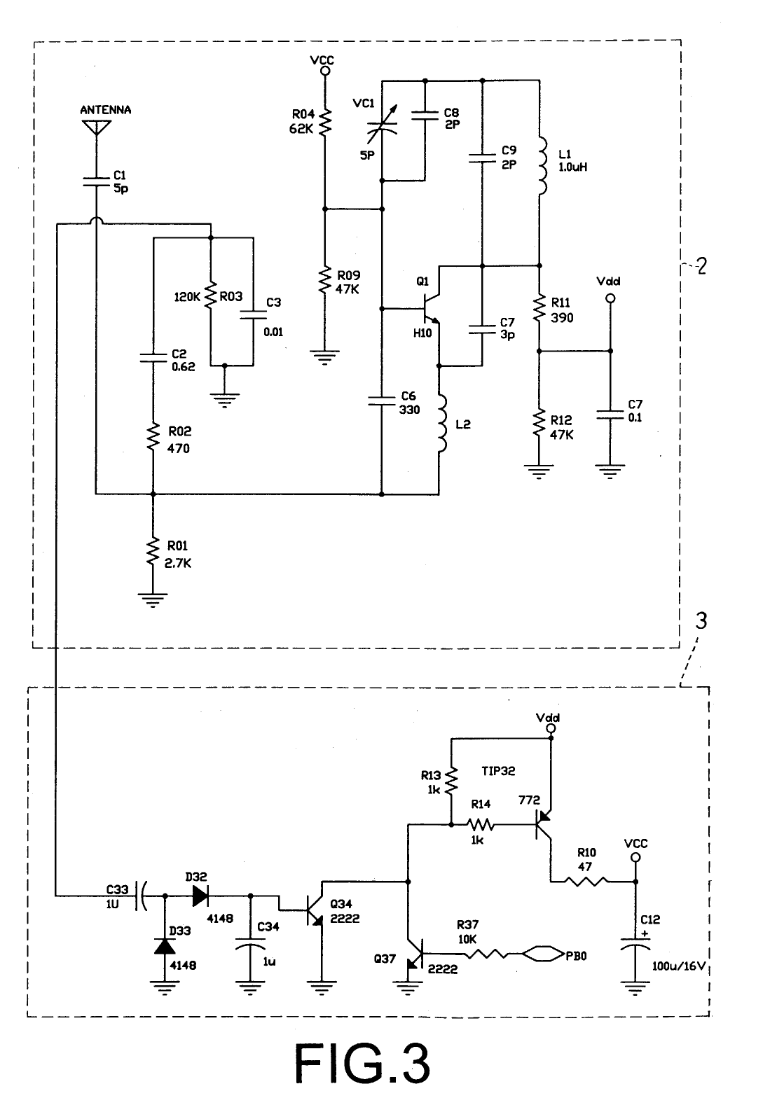

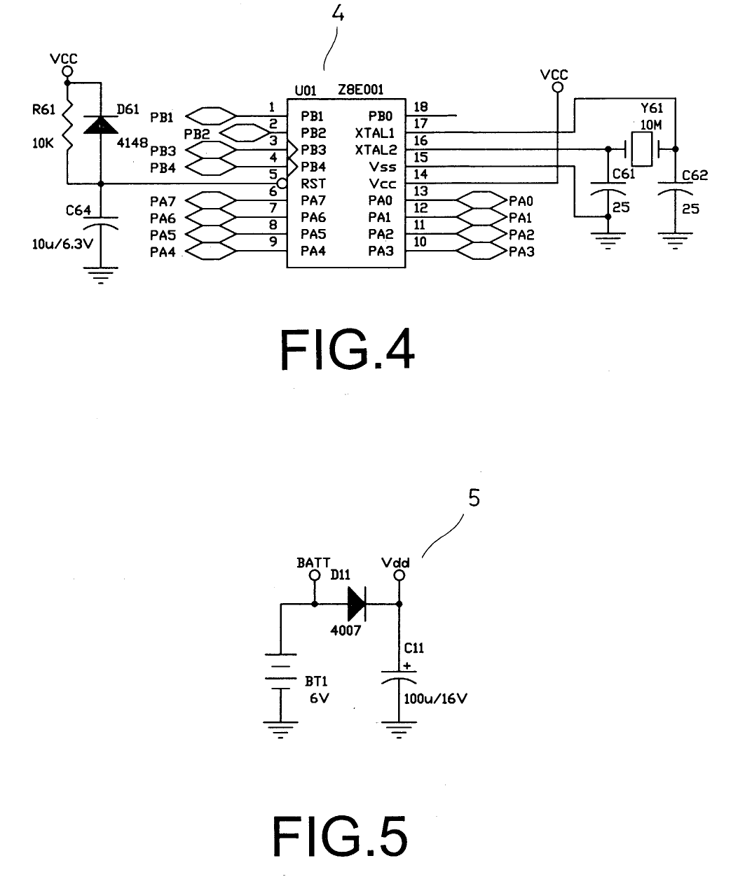

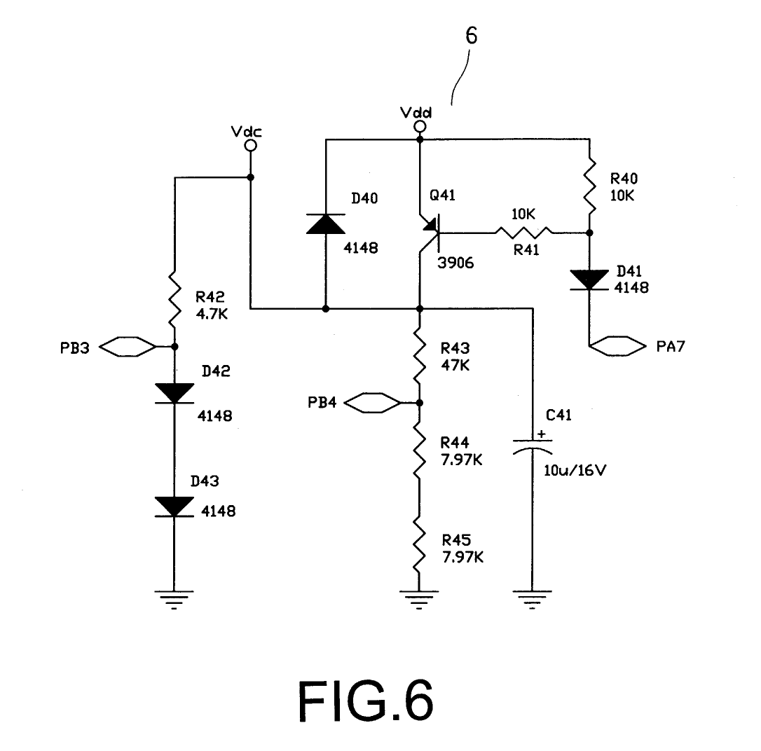

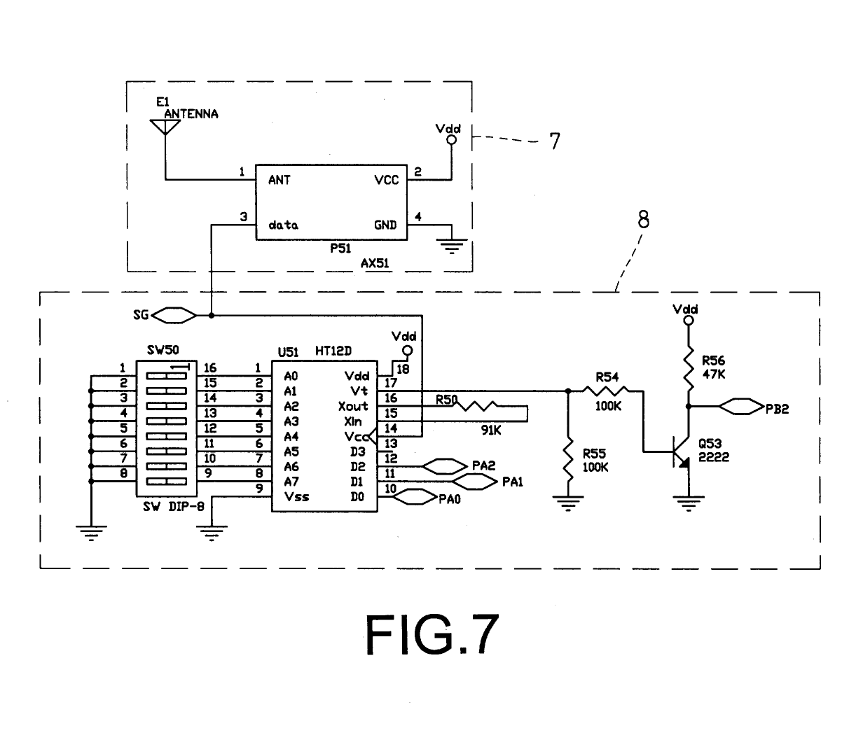

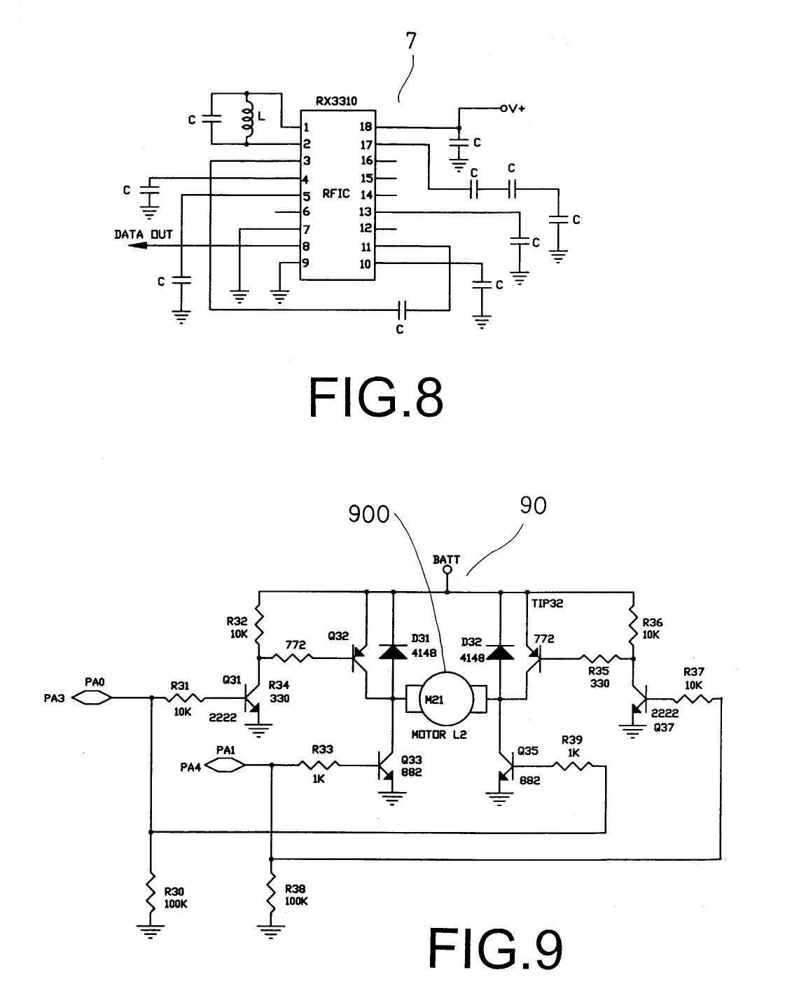

The emitter 1, referring to its circuit shown in FIG. 2, emits signals and generates both electric wave and electric field. The electric-field sensor 2, referring to its circuit shown in FIG. 3, receives the electric field generated by the emitter. The power switch circuit 3, as shown in FIG. 3, is connected with the electric-field sensor 2, able to be turned on to act. The central processing unit 4, having its circuit shown in FIG. 4, is connected with the power switch circuit 3, able to carry out judging and proofreading. The main electric circuit 5, as shown in FIG. 5, is connected with the central processing unit 4, able to be electrically connected. The power sensor 6, referring to its circuit shown in FIG. 6, is connected with the main power circuit 5 and the power switch circuit 3, able to sense power. The receiver 7, referring to its circuit shown in FIGS. 7 and 8, is connected with the main power circuit 5, able to receive the signal and the electric wave emitted and generated by the emitter 1. The decoder 8, referring to its circuit shown in FIG. 8, is connected with the receiver 7 and the central processing unit 4, able to decode the signal received by the receiver 7 and then send it to the central processing unit 4 for proofreading. The drive unit 9, referring to its circuits shown in FIGS. 9 to 12, is connected with the central processing unit 4.

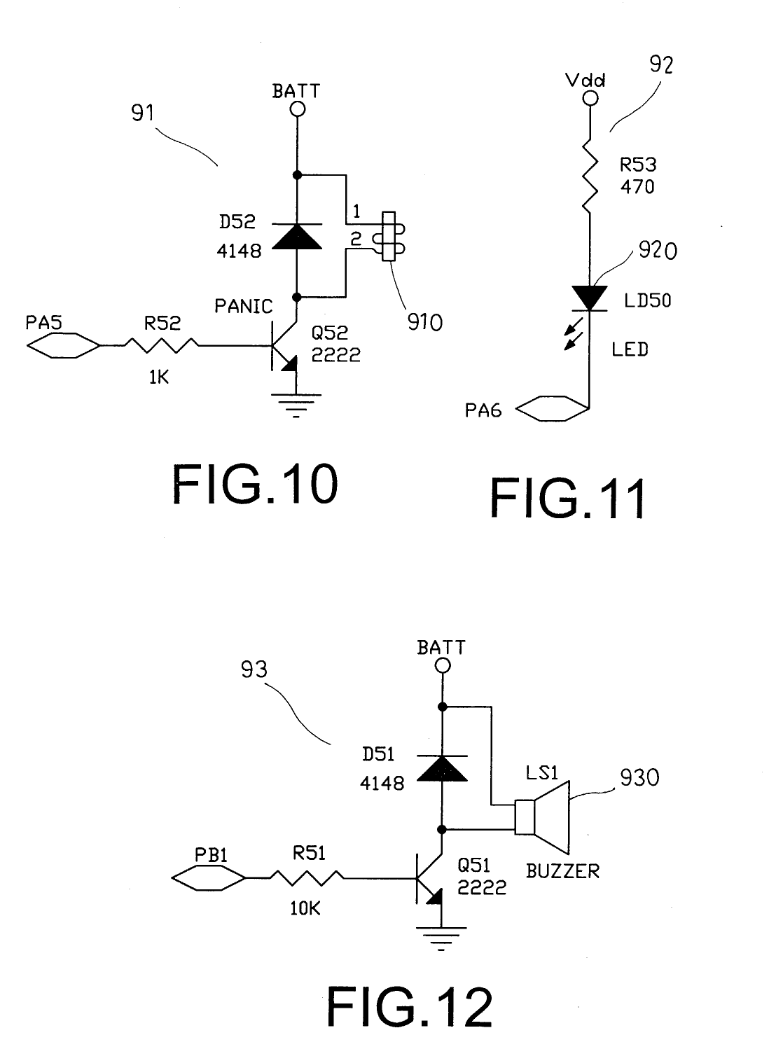

The drive unit 9 is provided with a locking-unlocking circuit 90 as shown in FIG. 9, an emergency action circuit 91 as shown in FIG. 10, an indicator 92, as shown in FIG. 11, and a warning member 93, referring to its circuit shown in FIG. 12. The locking-unlocking circuit 90 is able to drive its motor 900 to rotate clockwise or counterclockwise to carry out unlocking or locking of a remote-controlled lock. The emergency action circuit 91 is able to actuate its inductor 910 to carry out an emergency action. The indicator 92 is able to actuate its light emitting diode 920 to give out an indicating light, and the warning member 93 is able to actuate its beeper 930 to give out a warning sound.

Thus, when the emitter 1 emits signals and generates both electric wave and electric field, the electric-field sensor 2 can receive the electric field generated by the emitter 1, and the power switch circuit 3 is turned on to let the electric field connected with the main electric circuit 5 to let the power sensor 6 sense the power after the electric field is judged by the central processing unit 4. Synchronously, the receiver 7 can receive the signal and electric wave emitted and generated by the emitter 1, and after decoded by the decoder 8, the signal and the electric wave are sent to the central processing unit 4 to be proofread. Only after the signal and the electric wave are proofread by the central processing unit 4, can the drive unit 9 act to have the locking-unlocking circuit 90 driving its motor 900 to rotate clockwise or counterclockwise to carry out unlocking or locking of the remote-controlled lock, with the emergency action circuit 91 actuating its inductor 910 to carry out an emergency action, with the indicator 92 actuating its light emitting diode 920 to give out an indicating light, and with the warning member 93 actuating its beeper 930 to give out a warning sound. In another case, if the emitter 1 does not emit any signal, nor generate any electric wave and electric field, the main electric circuit 5 will not be connected, thus able to reduce power consumption and achieve effect of power saving.

As can be noted from the above description, this invention has the following advantages.

1. The main electric circuit cannot be connected until the emitter emits signals and generates both electric wave and electric field, and the electric-field sensor receives the electric field generated by the emitter and the power switch circuit is turned on to have electric field judged by the central processing unit.

2. The drive unit cannot carry out any action before the main electric circuit is connected to let the power sensor sense the power, and the receiver receives the signal and the electric wave emitted and generated by the emitter and the signal and the electric wave are decoded by the decoder and proofread by the central processing unit.

3. The locking-unlocking circuit of the drive unit is able to drive its motor to rotate clockwise or counterclockwise to carry out unlocking or locking of a remote-controlled lock.

4. The emergency action circuit of the drive unit is able to actuate its electric sensor to carry out an emergency action.

5. The indicator of the drive unit is able to actuate its light emitting diode to give out an indicating light.

6. The warning member of the drive unit is able to actuate its beeper to give out a warning sound.

7. The main power circuit is kept disconnected if the emitter does not emit any signal nor generate any electric wave or electric field, able to lower power consumption and achieve effect of power saving.

While the preferred embodiment of the invention has been described above, it will be recognized and understood that various modifications may be made therein and the appended claims are intended to cover all such modifications that may fall within the spirit and scope of the invention.

What is claimed is:

1. A power-saving electric circuit for a remote-controlled lock comprising:
an emitter emitting signals and generating both electric wave and electric field;
an electric-field sensor receiving said electric field generated by said emitter;
a power switch circuit connected with said electric-field sensor, said power switch circuit able to be turned on to function;
a central processing unit connected with said power switch circuit, able to carry out judging and proofreading of said signal;
a main power circuit connected with said central processing unit, able to be electrically connected and disconnected with said central processing unit;
a power sensor connected with said main power circuit and said power switch circuit, said power sensor able to sense power;
a receiver connected with said main electric circuit, said receiver able to receive said signal and said electric wave emitted and generated by said emitter;
a decoder connected with said receiver and said central processing unit, said decoder able to decode said signal received by said receiver, said signal sent to said central processing unit for proofreading after it is decoded by said decoder;
a drive unit connected with said central processing unit, consisting of a locking-unlocking circuit, an emergency action circuit, an indicator and a warning member, said locking-unlocking circuit able to drive its motor to rotate clockwise or counterclockwise to carry out unlocking or locking of a remote-controlled lock, said emergency action circuit able to actuate its inductor to carry out an emergency action, said indicator able to actuate its light emitting diode to give out an indicating light, said warning member able to actuate its beeper to give out a warning sound; and,
said electric-field sensor receiving said electric field generated by said emitter when said emitter emitting signal and generating both electric wave and electric field, said power switch circuit turned on to let said electric field connected with said main power circuit and let said power sensor sense the power after said electric field is judged by said central processing unit, said receiver receiving said signal and said electric wave emitted and generated by said emitter, said signal and said electric wave sent to said central processing unit for proofreading after they are decoded by said decoder, said drive unit able to function only after said electric wave is proofread by said central processing unit, said locking-unlocking circuit of said drive unit driving its motor to rotate clockwise or counterclockwise to carry out unlocking or locking of a remote-controlled lock, said emergency action circuit of said drive unit actuating its inductor to perform an emergency action, said indicator of said drive unit actuating its light emitting diode to give out an indicating light, said warning member of said drive unit actuating its beeper to give out a warning sound, said main power circuit unable to be electrically connected before said emitter emits said signal and generates both said electric wave and said electric field, able to lower power consumption and accordingly achieve effect of power saving.
